(19) United States
(12) Patent Application Publication
(10) Pub. No.: US 2005/0284567 A1
(43) Pub. Date: Dec. 29, 2005

(54) Bonding device and method

(75) Inventor: Po-Shan Huang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/168,610

(22) Filed: Jun. 27, 2005

(30) Foreign Application Priority Data
Jun. 25, 2004 (TW) 93118537

(51) Int. Cl. C09J 5/00

(52) U.S. Cl. 156/311; 156/308.4; 156/580

(57) ABSTRACT

A device (1) for bonding two components (31, 32) includes a heating unit (11) and a lifting device (13) used to drive the heating unit to move. The heating unit includes a pressing device (17) including a pressing plate (171). The pressing plate can conduct heat, and the pressing plate is adapted to press the components. The bonding device can prevent protuberances from forming in a connecting part between the bonding components and can achieve reliable hot pressing result.

### BACKGROUND OF THE INVENTION

1. Field of the Invention

The present invention relates to a device and a method for bonding two electrical components together, and especially to a device and a method used for bonding two electrical components together under constant temperature conditions.

2. General Background

A method of assembling a liquid crystal display (LCD) module generally comprises a step of electrically interconnecting a liquid crystal display panel, a drive integrated circuit (IC), a flexible printed circuit (FPC) and a printed circuit board (PCB).

A hot press bonding method is generally used in an LCD module assembling process in order to bond two electrical components together. There are two kinds of hot press bonding methods; one is a pulse hot press bonding method, and the other is a constant temperature hot press bonding method. A pulse hot press bonding method comprises the following steps: firstly, pressing two bonding components together; secondly, heating solder between the bonding components to a melted state using electric energy; and finally, cooling the solder between the bonding components in order to firmly connect the bonding components together. This method can prevent protuberances from forming in a connecting part between the bonding components, and can also prevent faulty soldering.

FIG. 5A shows a temperature-time relationship of a pulse hot press bonding process, and FIG. 5B shows a temperature-time relationship of a constant temperature hot press bonding process. In these graphs, t1 is a warm-up time of the hot pressing process, t2 is a working time, t3 is a cooling time, Tm is a melting temperature of the solder, and curves A and B represent the relation of time-temperature of the solder in the bonding process. In the pulse hot press bonding process shown in FIG. 5A, the solder is warmed up during t1 time and begins to melt at the temperature Tm, then the step of hot press bonding proceeds during time t2, and then a pressing head of the pulse hot press bonding device is detached from the pressed components at time A1 after a cooling time t3 has elapsed. At time A1, the solder is solidified, and the bonding components are connected together firmly. In the constant temperature hot press bonding process shown in FIG. 5B, the solder is warmed up during time t1 and begin to melt at the temperature Tm, then the step of hot press bonding proceeds during time t2, and then a pressing head of the constant temperature hot press bonding device is detached from the bonded components at time B1. At time B1, the solder is still in a melted state, because the temperature of the solder is higher than its melting temperature. The bonded components may at least partially separate from each other and create gaps therebetween, because the pressing force on the bonded components has been removed. This can leads to incomplete or faulty electrical communication.

The constant temperature hot press bonding device has a simple structure, low cost, and low power consumption. Therefore, notwithstanding the above-described problems encountered with the constant temperature hot press bonding process, this process is still favored by certain manufacturers.

What is needed, therefore, is a constant temperature hot press bonding device that can provide improved hot press bonding quality. What is further needed is a constant temperature hot press bonding method that can improve the hot press bonding quality.

### SUMMARY

In one preferred embodiment, a device for bonding two components includes a heating unit and a lifting device used to drive the heating unit to move. The heating unit includes a pressing device including a pressing plate. The pressing plate can conduct heat, and the pressing plate is adapted to press the components. The bonding device can prevent protuberances from forming in a connecting part between the bonding components and can achieve reliable hot pressing result.

In another preferred embodiment, a method for reliably bonding two components together includes: providing a heat conducting component; moving the heat conducting component to a top of an overlapping region of the bonding components; pressing and heating the overlapping region of the bonding components through a heating device on the heating conducting component; and lifting up the heating device, such that the heat conducting component continues to press the overlapping region of the bonding components until the bonding components have cooled down.

Other advantages and novel features will become more apparent from the following detailed description of preferred embodiments when taken in conjunction with the accompanying drawings, in which:

### BRIEF DESCRIPTION OF THE DRAWINGS

FIG. 1 is a schematic, side cross-sectional view of a constant temperature hot press bonding device in an non-working state according to a preferred embodiment of the present invention, together with two components placed therein;

FIG. 2 is another schematic, side cross-sectional view of the constant temperature hot press bonding device of FIG. 1, such view being perpendicular to that of FIG. 1;

FIG. 3 is similar to FIG. 1, but showing the constant temperature hot press bonding device in a working state;

FIG. 4 is a schematic, side cross-sectional view of a constant temperature hot press bonding device according to another preferred embodiment of the present invention, together with two components placed therein; and

FIG. 5A is a graph showing a temperature-time relationship in a typical pulse hot press bonding process, and FIG. 5B is a graph showing a temperature-time relationship in a typical constant temperature hot press bonding process.

### DETAILED DESCRIPTION OF PREFERRED EMBODIMENTS

Reference will now be made to the drawings to describe the preferred embodiments in detail.

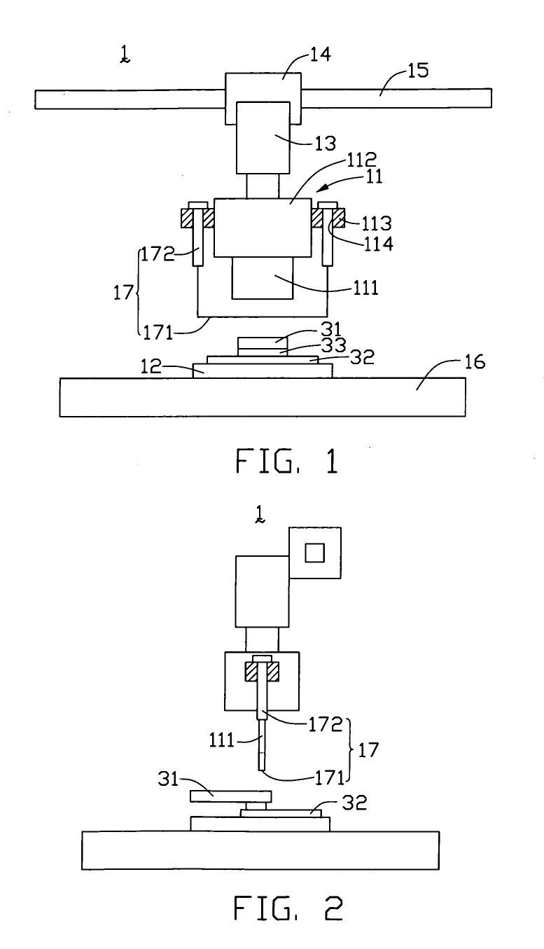

Referring to FIG. 1 and FIG. 2, a constant temperature hot press bonding device 1 includes a base 10, a heating unit 11, a lifting device 13 used to drive the heating unit 11 to move, a movable stage 14, and a horizontal framework 15 connecting with the movable stage 14. The movable stage 14 and the lifting device 13 are arranged on top of the heating unit 11. The base 10 is for supporting two bonding components 31 and 32 arranged under the heating unit 11.

The base 10 includes an X-Y stage 16, and an object stage 12 arranged on the X-Y stage 16. The X-Y stage 16 can move left and right and forward and rearward in a horizontal plane, which movement moves the object stage 12 to a desired position. Two bonding components 31 and 32 are arranged on the object stage 12, and a plurality of solder balls 33 are arranged in an overlapping region between the bonding components 31 and 32.

The heating unit 11 includes a heating head 111, a main body 112, two brackets 113, and a pressing device 17. The two brackets 113 are arranged on two edges of the main body 112. Each bracket 113 has a hole 114. The heating head 111 is arranged below the main body 112. The pressing device 17 includes two pressing components 172, and a pressing plate 171 that can conduct heat. Each pressing component 172 is a T-shaped cylinder set, which is fixed in a corresponding one of the holes 114. A diameter of the pressing component 172 is smaller than a diameter of the hole 114, so that the pressing component 172 can slide in the hole 114 freely. The pressing plate 171 is arranged between the heating head 111 and the overlapping region of the bonding components 31 and 32, so that the heating head 111 can heat the bonding components 31 and 32 through the pressing plate 171.

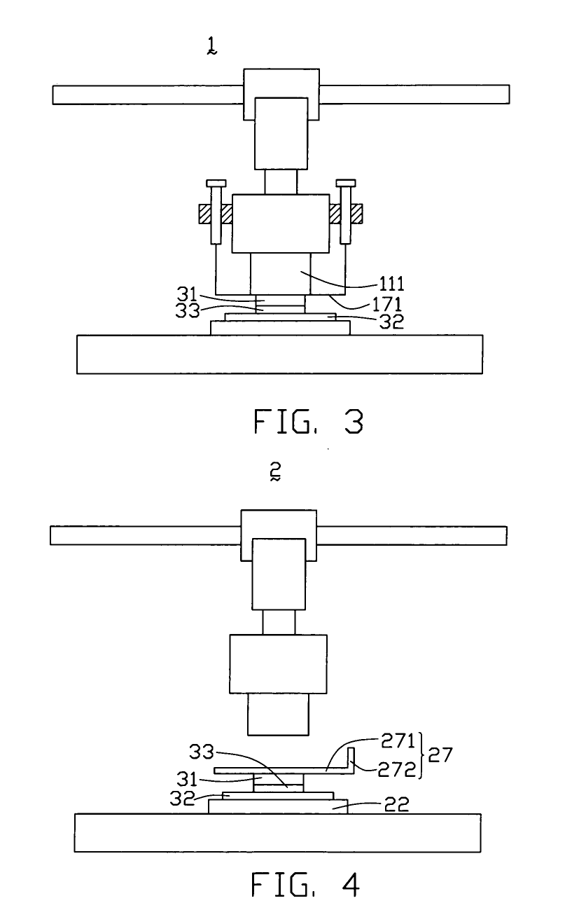

Referring to FIG. 3, in operation, the heating unit 11 is driven to move down until the heating head 111 contacts the pressing plate 171 and the pressing plate 171 presses on the overlapping region of the two bonding components 31 and 32. The solder balls 33 in the overlapping region are heated by the heating head 111 and the pressing plate 171, and the solder balls 33 begin to melt when they reach their melting temperature. After the solder balls 33 are melted, the heating head 111 is driven by the lifting device 13 to move up, so that the heating head 111 leaves the pressing plate 171. However, the pressing plate 171 remains on the overlapping region because of the gravity of the pressing plate 171 and continues to press and heat the bonding components 31 and 32. Once the heating head 111 has been moved to a predetermined height, the bonding components 31 and 32 and the solder balls 33 at the overlapping region are cooled. After the above-mentioned process has been completed, the solder balls 33 firmly connect the bonding components 31 and 32 together.

In the illustrated embodiment, the bonding component 31 is an FPC. The bonding component 32 is a PCB. The solder balls 33 can be made from terne alloy, or alternatively an anisotropic conductive film (ACF) can be used. The such as an plate 171 is a metal plate that can conduct heat and that resists warping, an iron plate.

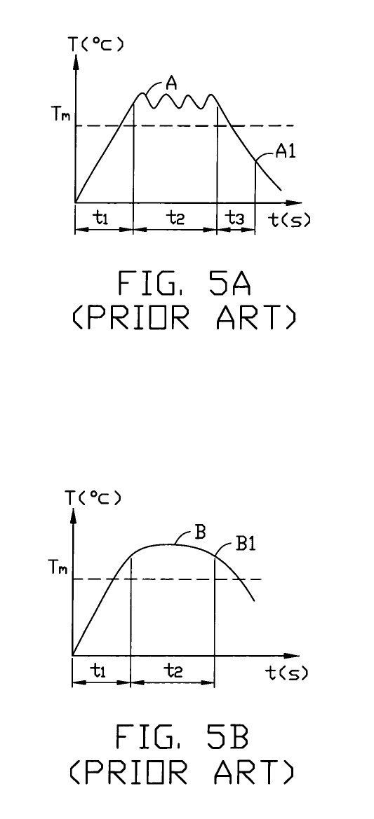

Referring to FIG. 4, another preferred embodiment of a constant temperature hot press bonding device 2 is similar to the above-described constant temperature bonding device 1, except that a pressing device 27 is an L-shaped iron plate. The pressing plate 27 includes a horizontal pressing component 271, and a bent portion 272 extending perpendicularly up from one edge of the pressing plate 27. The bent portion 272 makes it convenient to take hold of the pressing plate 27. An object stage 22 of the constant temperature hot press bonding device 2 is magnetic, to attract and attach the pressing plate 27 thereonto, and thereupon to drive the pressing plate 27 to press the bonding components 31 and 32 together.

In alternative embodiments, the object stage 22 can also be made from non-magnetic material. In such case, a magnetic device can be set below the bonding components 31 and 32 in order to attract the pressing plate 27. Further or alternatively, a spring can be used to press the bonding components 31 and 32 together.

A method using the constant temperature hot pressing device 1 or 2 comprises the following steps. Firstly, providing a heat conducting component, like the pressing component 171 or 271, and moving the heat conducting component 171 or 271 to a top of an overlapping region of the bonding components 31 and 32. Secondly, pressing and heating the overlapping region of the bonding components 31 and 32 through the heat conducting component. Thirdly, pressing a heating head 111 on the heat conducting component, and heating the overlapping region of the bonding components 31, 32 through the heat conducting component. Finally, lifting up the heating head 111, such that the heat conducting component continues to press the overlapping region with its gravity until the bonding components 31 and 32 and the solder balls 33 have cooled down.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A device for bonding two components together, comprising:
a heating unit; and
a lifting device used to drive the heating unit to move;
wherein the heating unit comprises a pressing device comprising a pressing plate, the pressing plate can conduct heat, and the pressing plate is adapted to press the components together.

2. The device as claimed in claim 1, further comprising an object stage used to lift the components.

3. The device as claimed in claim 2, wherein the pressing plate and the object stage attract each other.

4. The device as claimed in claim 1, wherein the pressing plate comprises iron, and a magnetic device is set below the components for attracting the pressing plate.

5. The device as claimed in claim 4, wherein the pressing device further comprises a bending component perpendicularly set on one edge of the pressing plate.

6. The device as claimed in claim 1, wherein the pressing device further comprises two pressing components perpendicularly set at two sides of the pressing plate.

7. The device as claimed in claim 6, wherein the heating unit further comprises one or more brackets retaining at least portions of the pressing components therein, such that the pressing components are slidable in the brackets.

8. The device as claimed in claim 7, wherein brackets comprise holes for the pressing components to slide in.

9. The device as claimed in claim 1, further comprising a lifting device for moving the pressing head up and down.

10. A method for reliably bonding two components together, comprising:
providing a heat conducting component;
moving the heat conducting component to a top of an overlapping region of the bonding components;
pressing and heating the overlapping region of the bonding components through a heating device on the heating conducting component; and
lifting up the heating device, such that the heat conducting component continues to press the overlapping region of the bonding components until the bonding components have cooled down.

11. The method as claimed in claim 10, wherein the heat conducting component presses the overlap region of the bonding components through magnetic attraction.

12. The method as claimed in claim 10, wherein the heat conducting component presses the overlap region of the bonding component through the gravity of the heat conducting component.

13. The method as claimed in claim 10, further comprising the step of lifting up the heat conducting component after the bonding components have cooled down.

14. In combination,
a moveable heating head;
a moveable thermally conductive pressing plate; and
two stacked components with a fusible material therebetween; wherein in a first stage, the pressing plate with the associated heating head initially presses downwardly against the stacked component to melt the fusible material, and in a second stage the heating head successively is withdrawn from the pressing plate to cool both the pressing plate and the stacked components while the pressing plate still downwardly pressing against the stacked components so as to have the fusible material solidified for fastening said stacked components.

15. The combination as claimed in claim 14, wherein in said first stage, the heating head directly intimately contacts the stacked components for heat transfer in addition to via said pressing plate.
